(19) United States
(12) Patent Application Publication
(10) Pub. No.: US 2019/0285522 A1
(43) Pub. Date: Sep. 19, 2019

(54) REMOVAL OF SALT FROM AQUEOUS SOLUTIONS FOR METABOLOMICS: TARGETED SALT PRECIPITATION

(71) Applicant: Agilent Technologies, Inc., Santa Clara, CA (US)

(72) Inventors: Genevieve Van de Bittner, Campbell, CA (US); Brian Phillip Smart, San Jose, CA (US)

(21) Appl. No.: 16/290,053

(22) Filed: Mar. 1, 2019

Related U.S. Application Data
(60) Provisional application No. 62/643,879, filed on Mar. 16, 2018.

(51) Int. Cl. G01N 1/40; B01D 11/04; B01D 15/38

(52) U.S. Cl. CPC G01N 1/405; G01N 2001/4061; B01D 15/3804; B01D 11/0492

(57) ABSTRACT

Methods for removing salts from a metabolite solution. The methods comprise forming an insoluble silver phosphate salt. Further methods include methods for removing hydrolyzed fluorous compounds. These methods comprise extraction with a fluorous solvent in the presence of a protonation reagent and/or chromatography on a fluorous affinity resin. Methods also include separating lysed cell debris and denatured proteins/disrupted enzymes from a metabolite mixture in a container with a filter, where live cells are grown prior to the lysis, either adherent to the filter or in suspension above the filter. The cells are then lysed in the container.

### CROSS-REFERENCE TO RELATED APPLICATIONS

This application claims priority to U.S. provisional patent application 62/643,879 filed Mar. 16, 2018, the entire disclosure of which is incorporated herein by reference.

### TECHNICAL FIELD

The present invention relates to the field of metabolomics, including compositions, kits, systems and methods for separating salts and fluorous compounds from a solution comprising metabolites.

### BACKGROUND

The science of metabolite profiles, metabolomics, may be used to evaluate the health of an individual, to develop new therapeutics, for synthetic biology, for environmental science, to test food, and for forensic toxicology. The metabolome is a mixture of metabolites obtained from a biological sample such as a cell, body fluid, tissue, organ and/or organism. Various metabolites which are typically substrates and/or products of at least one metabolic process may be obtained by contacting a biologic sample with an ionic liquid as described in US Patent Publications US 2014/0273080 and US 2015/0369711, both incorporated herein by reference.

An ionic liquid lyses cells and interacts with enzymes and other proteins to preserve metabolites. However, an ionic liquid may interfere with detection and analysis of metabolites.

Various methods in the ionic workflow may be employed for removing the cation of an ionic liquid from an aqueous solution comprising metabolites. These methods include contacting an aqueous solution which comprises metabolites and an ionic liquid with an organic solvent in order to produce a dispersed microdroplet ionic liquid-organic solvent composition which is then contacted with an ion exchange composition as described in US 2014/0273080, the disclosure of which is incorporated herein by reference.

The cation of an ionic liquid may also be separated from a sample which comprises metabolites by producing a fluorous salt of the cation of the ionic liquid, which is then separated with a fluorous affinity material as described in US 2015/0369711, the disclosure of which is incorporated herein by reference. While removing the cation of an ionic liquid from a sample comprising metabolites in a metathesis reaction, salts are typically generated. These salts comprise the cationic counterion of a fluorous anion and the anion of an ionic liquid. The salts may interfere with detection of metabolites in a sample.

The aqueous solution comprising metabolites may also comprise some hydrolyzed products of a fluorous anion. The hydrolyzed fluorous compounds may also interfere with detection and analysis of metabolites in a sample.

Several different approaches have been attempted to remove metathesis by-product salts from an aqueous solution of metabolites. Previous approaches include evaporation and re-dissolution of the metabolites in an organic solvent which may lead to a major loss of nearly all classes of polar metabolites. Other approaches include salt precipitation through formation of a relatively insoluble silver chloride salt which may lead to a loss of phosphate-containing metabolites, magnetic ionic liquids, and a combination of size exclusion chromatography (SEC), ion exchange chromatography.

Currently, there is still a need for methods by which a metathesis reaction may be carried out such that species formed in the reaction are mass spectrometry-compatible and without a loss of either polar metabolites or phosphate-containing metabolites. There is also a need for methods by which salts and/or hydrolyzed fluorous compounds are removed efficiently from an aqueous sample comprising metabolites.

### SUMMARY

The present disclosure addresses at least some of these and other needs and provides compositions and methods for removing salt(s) and hydrolyzed fluorous compounds.

In one aspect, the disclosure provides a method for preparing a solution comprising metabolites, the method comprising: reacting a mixture, optionally in the presence of a fluorous solvent, the mixture comprising metabolites and an ionic liquid comprising a phosphate-containing anion and/or a phosphate-containing additive, with a fluorous compound comprising silver cations, and thereby separating the cation of the ionic liquid from the metabolites and obtaining a solution comprising the metabolites and a silver phosphate precipitate.

The methods may be further used in order to isolate other cellular compounds along with metabolites. Such compounds may include, but are not limited to, DNA, RNA, and/or other molecules and/or organelles typically found in a living cell.

The method may further comprise a step of removing the silver phosphate precipitate from the solution.

The phosphate-containing anion may be a compound to which one or more phosphate groups are attached. The phosphate-containing additive may be a compound to which one or more phosphate groups are attached.

The phosphate-containing anion may contain a monophosphate group, diphosphate group, triphosphate group, or any combination thereof. The phosphate-containing anion may be methylene diphosphonate (medronic acid).

The methods may be conducted in the presence of a phosphate-containing additive which may be any compound containing a phosphate group. The phosphate-containing additive may comprise a monophosphate group, diphosphate group, triphosphate group, or any combination thereof.

In some of the embodiments, the anion is a mixture of the phosphate-containing counterion with acetate and/or formate. In one preferred embodiment, the reacting mixture comprises water, acetonitrile, formic acid, fluorous affinity liquid, the ionic liquid with its phosphate-containing anion, and the fluorous anion and its silver cation.

Any of these methods may be conducted in the presence of a buffer which may be selected from ammonium acetate, ammonium bicarbonate, formic acid, acetic acid, ammonium formate, 4-methylmorpholine, 1-methylpiperidine, triethylammonium acetate, pyrrolidine or any combination thereof to buffer protons from excess phosphate-containing compounds used in the ionic liquid workflow.

Any of these methods may be conducted in the presence of a fluorous solvent which may be selected from a perfluorocarbon (PFC), hydrofluoroether (HFE), and any combination thereof. Particularly preferred organic solvents are acetonitrile and HFE-7100.

Any of these methods may be conducted with the fluorous compound that has the following formula (VII):

[Z¹—(CH₂)ₘ—SO₂—N(⁻)—SO₂—(CH₂)ₚ—Z²].M⁺ (VII)

wherein: M⁺ is silver;
Z¹ and Z² are independently a perfluoroalkyl, an alkyl, a substituted alkyl, a perfluoroaryl, an aryl, or a substituted aryl, wherein Z¹ and Z² include together a combined total of 8 or more fluorinated carbon atoms;
and m and p are independently 0, 1 or 2.

The fluorous compound may be bis((perfluorohexyl)sulfonyl)imide.

In further embodiments, these methods may further comprise removing a hydrolyzed fluorous compound from the metabolite solution. This may be accomplished by extracting the metabolite solution with a fluorous solvent in the presence of a protonation reagent and/or by binding the hydrolyzed fluorous compound with a fluorous affinity resin.

The methods may further comprise removing a hydrolyzed fluorous compound from the metabolite solution, comprising:
extracting the metabolite solution comprising the hydrolyzed fluorous compound with a fluorous solvent in the presence of a protonation reagent, and thereby lowering a pH of the solution at or below the pKa value of the hydrolyzed fluorous compound, protonating the fluorous compound and obtaining an aqueous phase comprising metabolites and an organic phase comprising the protonated fluorous compound; and
separating the aqueous phase comprising metabolites from the organic phase.

The methods may further comprise removing a hydrolyzed fluorous compound from the metabolite solution, comprising:
loading the metabolite solution comprising the hydrolyzed fluorous compound onto a fluorous affinity resin, and thereby binding the fluorous compound to the resin; and
eluting the solution comprising metabolites.

Further embodiments provide a method for removing a hydrolyzed fluorous compound from an aqueous metabolite solution, the method comprising:
a) extracting the metabolite solution comprising the hydrolyzed fluorous compound with a fluorous solvent in the presence of a protonation reagent, and thereby lowering a pH of the solution at or below the pKa value of the hydrolyzed fluorous compound, protonating the fluorous compound and obtaining an aqueous phase comprising metabolites and an organic phase comprising the protonated fluorous compound; and
b) separating the aqueous phase comprising metabolites from the organic phase.

Instead of steps a) and b), or in addition to steps a) and b), the method may also comprise:
c) loading the metabolite solution comprising the hydrolyzed fluorous compound(s) onto a fluorous affinity resin and thereby binding the fluorous compound(s) to the resin; and
d) eluting the solution comprising metabolites.

The water-soluble fluorous compound may be a fluorous sulfonate; fluorous sulfonamide, or any mixture thereof. The fluorous solvent may be a perfluorocarbon, hydrofluoroether, or any mixture thereof.

The protonation reagent may be an organic and/or inorganic acid. The protonation reagent may be hydrogen halide. Particularly preferred protonation reagents include, but are not limited to, hydrochloric acid, hydrobromic acid, boric acid, phosphoric acid, formic acid, carboxylic acid, acetic acid, and any mixture thereof.

The fluorous affinity resin may comprise silicon dioxide derivatized with fluorous carbon chains. The fluorous affinity resin may comprise a fluorous styrene-based polymer, fluorous benzyl-based polymer, fluorous divinylbenzene polymer, or any mixture thereof.

The elution solvent is polar and water-miscible. The elution solvent may comprise methanol, ethanol, isopropanol, acetone, acetonitrile, tetrahydrofuran, or any mixture thereof. The elution solvent may optionally comprise water and optionally also comprise a protonation reagent and optionally also comprise a polar organic solvent, such as acetonitrile.

Any of the above methods, may further comprise:
growing cells in a double-bottom container comprising an internal chamber with a filter bottom, the internal chamber being suspended in an external chamber and the internal chamber being insertable and removable from the external chamber; wherein the cells are optionally adhered to the filter bottom;
filtering the cells adhered to the filter bottom to remove growth media;
optionally washing the cells with an isotonic solution, such as phosphate buffered saline;
lysing the cells by contacting the cells with an ionic liquid in the internal chamber, thereby obtaining a mixture comprising metabolites and the ionic liquid;
filtering the mixture through the filter bottom; and
collecting the mixture in the external chamber.

### BRIEF DESCRIPTION OF THE DRAWINGS

FIG. 1 is a schematic of a salt metathesis reaction producing a silver-phosphate insoluble salt.

FIG. 2 is a schematic of an ionic liquid comprising a phosphate-containing anion. The HMIM-H₂PO₄ ionic liquid was synthesized from HMIM-Cl using methods described in the literature (Maksimov, A L et al. Petroleum Chem, 2014, 54, 4, 283-287).

FIG. 3 is an LCMS analysis of metabolite standards processed using a salt-precipitation method according to the present disclosure.

FIG. 4 is a schematic of a hydrolysis reaction of NTf₆.

FIG. 5A are spectra detecting high levels of fluorous sulfonamide (left) and fluorous sulfonate (right) in an aqueous sample comprising metabolites after extraction with fluorous solvent HFE-7100 without protonation. Upper panels are spectra for blank controls. Bottom panels show high levels of fluorous sulfonamide (left) and fluorous sulfonate (right).

FIG. 5B are spectra detecting high levels of fluorous sulfonamide (left) and fluorous sulfonate (right) in an aqueous sample comprising metabolites after extraction with fluorous branched ether without protonation. Upper panels are spectra for blank controls. Middle panels are spectra for pre-wash samples. Bottom panels are for post-wash samples.

FIG. 6A are spectra detecting a sufficient removal of protonated fluorous sulfonamide from a sample comprising metabolites by extraction with a fluorous solvent in the presence of an acid. The upper panel is a control extraction with no acid. The middle panel is extraction in the presence of 0.1% or 1% of formic acid. The bottom panel is extraction in the presence of 0.1% or 1% formic acid.

FIG. 6B are spectra detecting insufficient removal of fluorous sulfonate which was not sufficiently protonated. The upper panel is a control extraction with no acid. The middle panel is extraction in the presence of 0.1% or 1% of formic acid. The bottom panel is extraction in the presence of 0.1% or 1% formic acid.

FIG. 7 are spectra detecting a sufficient removal of fluorous sulfonate from an aqueous sample comprising metabolites by chromatography on a fluorous resin. The upper panel is a pre-column sample comprising fluorous sulfonate. Fractions 1-5 are fractions eluted from the fluorous resin. In the left panel, the elution solvent is 8:2 H₂O:acetonitrile in the presence of 0.1% formic acid. In the middle panel, the elution solvent is 6:4 H₂O:acetonitrile in the presence of 0.1% formic acid. In the right panel, the elution solvent is 4:6 H₂O:acetonitrile in the presence of 0.1% formic acid.

FIG. 8A are bar graphs showing the relative level of various metabolites before and after passage of the metabolite-containing solution through a Berry&Associates fluorous resin.

FIG. 8B are bar graphs showing the relative level of various metabolites before and after passage of the metabolite-containing solution through a Silicycle Si-fluorochrome fluorous resin.

FIG. 9 depicts one embodiment of a double-bottom container for growing and lysing cells.

### DETAILED DESCRIPTION

Some aspects of this disclosure relate to salt metathesis methods in the ionic liquid workflow by which an insoluble silver phosphate salt precipitate is formed.

The present salt metathesis methods improve detection, analysis and separation of metabolites in a sample, including detection of metabolites by liquid chromatography and mass spectrometry methods (LCMS) and/or ion mobility-mass spectrometry. Methods of the present disclosure may include analyzing metabolites by liquid chromatography-mass spectrometry systems. The analysis may include liquid chromatography, including a high-performance liquid chromatography, a micro- or nano-liquid chromatography or an ultra-high pressure liquid chromatography. The analysis may also include liquid chromatography/mass spectrometry (LCMS), ion mobility—mass spectrometry, gas chromatograph/mass spectrometry (GCMS), capillary electrophoresis (CE), or capillary electrophoresis chromatography (CEC).

The term “metabolites” is used herein in its conventional sense to refer to one or more compounds which are substrates or products of a metabolic process. Metabolites may include substrates or products which are produced by metabolic processes in a living cell including, but not limited to glycolysis, tricarboxylic acid cycle (i.e., TCA cycle, Krebs cycle), reductive pentose phosphate cycle (i.e., Calvin cycle), glycogen metabolism, pentose phosphate pathway, among other metabolic processes. Accordingly, metabolites may include but are not limited to glucose, glucose-6-phosphate, fructose-6-phosphate, fructose-1,6-phosphate, glyceraldehyde 3-phosphate, dihydroxyacetone phosphate, 1,3-bisphosphoglycerate, 3-phosphoglycerate, 2-phosphoglycerate, phosphoenolpyruvate, pyruvate, acetyl CoA, citrate, cis-aconitate, d-isocitrate, α-ketoglutarate, succinyl CoA, succinate, fumarate, malate, oxaloacetate, ribulose 1,5-bisphosphate, 3-phosphoglycerate, 1,3-bisphosphoglycerate, glyceraldehyde 3-phosphate, ribulose-5-phosphate, ethanol, acetylaldehyde, pyruvic acid, 6-phosphogluconolactone, 6-phosphogluconate, ribose-5-phosphate, xylulose-5-phosphate, sedoheptulose 7-phosphate, erythrose 4-phosphate, among other metabolites.

In the ionic liquid workflow of the present disclosure, an ionic liquid is added to a biologic sample in order to lyse cells and/or denature/enzymatically disrupt proteins and produce a mixture comprising metabolites. By “lyse” cells, it is meant that the cells are ruptured or broken open such that the internal contents of the cells, including metabolic enzymes are released into the surrounding medium (e.g., ionic liquid which is usually a solution of an ionic liquid in water). In some embodiments, a cell lysis may further include a lysis of cellular organelles, for example the nucleus, mitochondria, ribosomes, chloroplasts, lysosomes, vacuoles, Golgi apparatus, centrioles, etc. such that the contents of the cellular organelles are also released into the surrounding medium.

The term “biological sample” refers to a whole organism or a subset of its tissues, cells and/or components (e.g. body fluids, including but not limited to blood, mucus, lymphatic fluid, synovial fluid, cerebrospinal fluid, saliva, amniotic fluid, amniotic cord blood, urine, vaginal fluid and semen). A “biological sample” can also refer to a homogenate, lysate or extract prepared from a whole organism or a subset of its tissues, cells or component parts, or a fraction or portion thereof, including but not limited to, for example, plasma, serum, spinal fluid, lymph fluid, the external sections of the skin, respiratory, intestinal, and genitourinary tracts, tears, saliva, milk, blood cells, tumors, organs. In certain embodiments, the biologic sample has been removed from an animal, plant, and/or fungus.

Biological samples of the invention may comprise cells. The term “cells” is used in its conventional sense to refer to the basic structural unit of a living eukaryotic and prokaryotic organism. In certain embodiments, cells include prokaryotic cells, such as bacteria. In other embodiments, cells include eukaryotic cells which may include, but are not limited to, tissue culture cell lines, yeast cells and primary cells which may be obtained from an animal, plant and/or fungus.

The term “small molecule” means any chemical compound which is not a polymer.

After the cell lysis/protein denaturation/enzymatic disruption has been completed and proteins/cell debris are removed from the sample, the cation of an ionic liquid is removed from an aqueous solution comprising metabolites by a salt metathesis reaction with a fluorous compound.

The term “salt metathesis reaction” refers to the transposition chemical process of exchanging counterions between the two compounds.

In the present methods, the salt metathesis reaction may be represented by the following scheme 1:

A-B+C-D→A-D+C-B (Scheme 1)
Wherein:
   A is the cation of an ionic liquid,
   B is an anion counterion of an ionic liquid,
   C is a cation counterion of the fluorous anion D,
   D is a fluorous anion,
   A-D is a complex between the cation of an ionic liquid and a fluorous anion; and
   C-B is an insoluble salt precipitate, silver phosphate or other insoluble salts of silver and phosphate-containing compounds.

The term “insoluble salt” means an organic or inorganic salt which is poorly soluble in distilled water at room temperature (23° C.) and standard-sea level pressure of 101.325 kilopascals. If no more than 0.1 g of a particular salt may be dissolved in 100 ml of distilled water at room temperature (23° C.) and 101.325 kilopascals, the salt is referred in this disclosure as insoluble salt. An insoluble salt forms precipitates in a metabolite solution at room temperature. Examples of insoluble salts include silver chloride and silver phosphate.

An ionic liquid is a salt in which counterions are poorly coordinated, and which results in the salts being in liquid form below 100° C. The term “ionic liquid” is used in its conventional sense to refer to a salt in liquid state. The ionic liquid may comprise water and other additives. For example, the ionic liquid may be a mixture with water. When mixed with water, the ratio of the ionic liquid to water may be in the range from 99:1 to 1:99 by weight. In this disclosure, an ionic liquid comprising water is referred to as an ionic liquid.

Suitable ionic liquids for the present methods contain at least one or more organic cations and at least one or more of anion counterions.

The ionic liquid anion counterions may be phosphates or phosphate-containing counterions. The ionic liquid anion counterion may also in part be an LCMS-friendly counterion, such as formate or acetate.

In some preferred embodiments, an ionic liquid comprises a phosphate-containing anion. The phosphate-containing anion may be any compound to which one or more phosphate groups are attached. In some embodiments, phosphate-containing anions include, but are not limited to, a monophosphate group, diphosphate group, triphosphate group, and any combination thereof. Phosphate-containing anions include dihydrogen phosphate, hydrogen phosphate, phosphate, and any combination thereof.

Any of these methods may be conducted in the presence of a buffer which may be selected from ammonium acetate, ammonium bicarbonate, formic acid, acetic acid, ammonium formate, 4-methylmorpholine, 1-methylpiperidine, triethylammonium acetate, and/or pyrrolidine to buffer protons from excess phosphate-containing compounds used in the ionic liquid workflow. In one preferred embodiment, 100 mM ammonium acetate (pH 9.2) may be used to buffer the excess dihydrogen phosphate formed when HMIM dihydrogen phosphate is used in the ionic liquid workflow with silver NTf₆.

Any ionic liquid suitable for extracting metabolites from a biologic sample may be used in the present methods. Any of these ionic liquids are formulated as comprising at least one of the following anionic counterions: acetate, phosphate-containing counterions, formate, carbonate, bicarbonate, nitrate, borate, and any mixtures thereof. At least one of the anionic counterions or any mixture thereof may be present in an ionic liquid at the time the ionic liquid is reacted with a biologic sample. In addition or in alternative, at least one of the anionic counterions or any mixture thereof may be added at any time to a mixture comprising metabolites and an ionic liquid prior to a salt metathesis reaction.

In the present methods, the ionic liquid may contain a cation according to any of formulas (I)-(VI).

In some embodiments, the ionic liquid contains a cation of Formula (I):

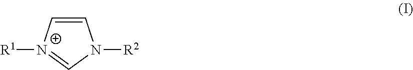

where each of R¹ and R² is independently hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl or substituted heteroarylalkyl.

In some embodiments, the ionic liquid contains a cation of Formula (II):

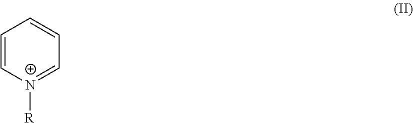

where R is hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl or substituted heteroarylalkyl.

In some embodiments, the ionic liquid contains a cation of Formula (III):

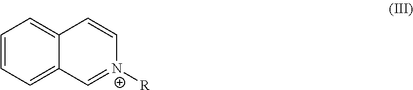

where R is hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl or substituted heteroarylalkyl.

In some embodiments, the ionic liquid contains a cation of Formula (IV):

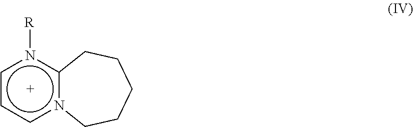

where R is hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl or substituted heteroarylalkyl.

In some embodiments, the ionic liquid contains a cation of Formula (V):

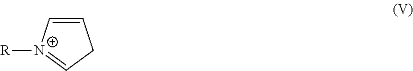

where R is hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl or substituted heteroarylalkyl.

In some embodiments, the ionic liquid contains a cation of Formula (VI):

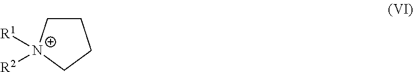

where each of R¹ and R² is independently hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl or substituted heteroaryl alkyl.

In some of the present methods, a mixture of at least two or more ionic liquids is used.

In some preferred embodiments, an ionic liquid comprises 1-hexyl-3-methyl-imidazolium (HMIM) and/or 1-butyl-3-methyl-imidazolium (BMIM) and at least one or more of the following anionic counterions: acetate, phosphate-containing anions, formate, carbonate, bicarbonate, nitrate, borate, and any mixture thereof.

In some preferred embodiments, an ionic liquid comprises HMIM and/or BMIM and a phosphate-containing anion and optionally, at least one or more from the following anions: acetate, formate, carbonate, bicarbonate, nitrate, and borate. The phosphate-containing anion may be any compound to which a phosphate group is attached. The phosphate-containing anion may contain dihydrogen phosphate, hydrogen phosphate, phosphate, and any combination thereof. A phosphate containing anion may contain one or several phosphate groups.

In some preferred embodiments, HMIM dihydrogen phosphate is used either alone or in combination with other ionic liquids and/or anionic counterions in a salt metathesis reaction.

The present salt metathesis methods are conducted with any of the ionic liquids described above and at least one fluorous compound with the following general formula (VII).

[Z¹—(CH₂)ₘ—SO₂—N(⁻)—SO₂—(CH₂)ₚ—Z²].M⁺ (VII)

wherein: M⁺ is a cation counterion which may be a metal ion and/or acid, wherein silver, barium or lead is a particularly preferred cation counterion; and
Z¹ and Z² are independently a perfluoroalkyl, an alkyl, a substituted alkyl, a perfluoroaryl, an aryl, or a substituted aryl, wherein Z¹ and Z² include together a combined total of 8 or more fluorinated (e.g., perfluorinated) carbon atoms (e.g., 9 or more, 10 or more, 11 or more, 12 or more, 13 or more, 14 or more, 15 or more, 16 or more, 17 or more, 18 or more, 19 or more, 20 or more, 30 or more or 40 or more fluorinated carbon atoms); and m and p are independently 0, 1 or 2.

In certain embodiments of formula (VII), Z¹ and Z² are the same groups. In certain embodiments of formula (VII), Z¹ and Z² are different groups. In certain embodiments of formula (VII), Z¹ and Z² are each a fluorinated or perfluorinated group. In certain embodiments of formula (VII), at least one of Z¹ and Z² is a fluorinated or perfluorinated group. In certain embodiments of formula (VII), Z¹ and Z² are each a perfluoroalkyl. In certain embodiments of formula (VII), Z¹ and Z² are each perfluorobutyl. In certain embodiments of formula (VII), Z¹ and Z² are each perfluoropentyl. In certain embodiments of formula (VII), Z¹ and Z² are each perfluorohexyl. In certain embodiments of formula (VII), Z¹ and Z² are each a perfluoroheptyl. In certain embodiments of formula (VII), Z¹ and Z² are each a perfluorooctyl. In certain embodiments of formula (VII), Z¹ and Z² are each a perfluoroaryl. In certain embodiments of formula (IX), Z¹ and Z² include together a combined total of 10 or more perfluorinated carbon atoms. In certain embodiments of formula (VII), Z¹ and Z² include together a combined total of 12 or more perfluorinated carbon atoms.

In certain embodiments of formula (VII), m and p are each 0. In certain embodiments of formula (VII), m+p=1. In certain embodiments of formula (VII), m+p=2. In certain embodiments of formula (VII), m+p=3. In certain embodiments of formula (VII), m+p=4.

Suitable cation counterions in the fluorous compound of formula (VII) include silver, barium or lead. Particularly preferred cation counterions include silver.

One preferred fluorous compound in this disclosure is bis((perfluorohexyl)sulfonyl)imide which may be formulated with silver cationic counterion.

In a salt metathesis method of this disclosure, a cation counterion for the fluorous compound of formula (VII) and an anion counterion for an ionic liquid are selected such that: an insoluble silver phosphate salt is formed during the salt metathesis reaction between the cation counterion and the anion counterion.

When the insoluble salt is formed, it may be removed from an aqueous solution comprising metabolites by any conventional method for separating a solid from a liquid, including, but not limited to, filtration, centrifugation and/or decanting. The salt removal may be complete or partial when less than 100%, but more than 50% of salt precipitate is removed from the solution.

Salt metathesis methods of the present disclosure may be conducted in the presence of a fluorous solvent which is not water-miscible and forms a separate organic phase into which the fluorous salt of the ionic liquid dissolves during the metathesis reaction. The metathesis reaction may also comprise a water-miscible organic solvent and/or other additives. Suitable water-miscible solvents include, but are not limited to acetonitrile, methanol, ethanol and any mixture thereof. Other additives may include formic acid or acetic acid.

Suitable fluorous solvents include, but are not limited to, perfluorocarbons (PFCs) and hydrofluoroethers (HFEs). Perfluorocarbons include, but are not limited to, perfluorohexane, perfluoromethylcyclohexane and perfluorodecalin. Hydrofluoroethers include, but are not limited to, nanofluorobutyl methyl ether (e.g., HFE-7100). In some embodiments, the fluorous solvent is a hydrofluoroether, e.g. HFE-7100. The fluorous solvent may be neat or it may comprise additives.

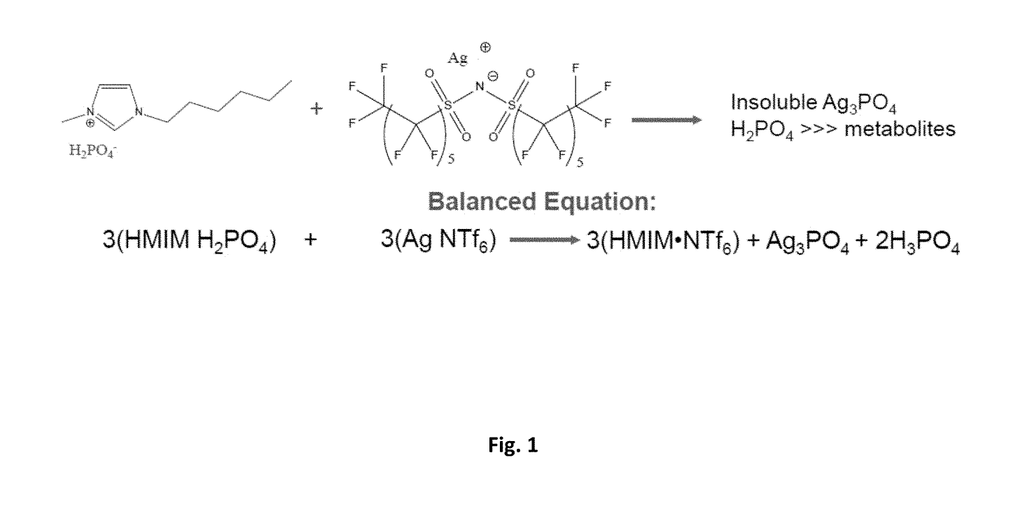

Referring to FIG. 1, it is a schematic of a salt metathesis reaction in which an insoluble salt is formed. In the reaction of FIG. 1, an ionic liquid comprises a phosphate-containing anion counterion. A fluorous compound comprises a silver cation counterion. During the salt metathesis reaction, a silver-phosphate precipitate is formed which then is removed from the solution comprising metabolites by any conventional method for separating a solid from a liquid, including, but not limited to, filtration, centrifugation and/or decanting.

Preferred embodiments include salt metathesis methods conducted with a fluorous compound comprising silver as a cation counterion and an ionic liquid comprising a phosphate-containing anion counterion either alone or in combination with any other anion counterions.

Preferred embodiments also include salt metathesis methods conducted with a fluorous compound comprising iron as a cation counterion and an ionic liquid comprising a phosphate-containing anion counterion either alone or in combination with any other anion counterions.

Preferred embodiments also include an ionic liquid comprising one or more of the following counterions: formate, carbonate, bicarbonate, acetate and/or nitrate. These ionic liquids can be used in combination with a phosphate-containing compound additive and/or an ionic liquid comprising a phosphate-containing anion.

Any of the above described metathesis methods may be conducted in the presence of at least one additive. For example, a phosphate-containing compound may be added as an additive to an ionic liquid which is then reacted with a fluorous compound comprising silver cation counterion. A phosphate-containing additive may be any compound to which one or more phosphate groups are attached.

The salt removal methods of this disclosure include a salt-precipitation reaction of silver counterions with phosphate-containing counterions. The salt-precipitation reaction may be optimized by adjusting temperature and pH.

The salt-precipitation methods may be carried out with mixing, vortexing and/or sonication. One of the advantages of the present salt-precipitation methods is a composition of the salt-precipitation reaction may be optimized for a particular metabolite or a set of metabolites of interest. The present salt-precipitation reaction may be further optimized based on other parameters such as the nature of a salt itself, i.e. its solubility constant in a particular solvent mixture, a degree of salt reduction needed, temperature of the solution, and other contents of the solution.

The salt-precipitation methods of this disclosure improve previous conventional methods in which counterions, silver and chloride, form an insoluble salt that precipitates out of an aqueous metabolite-containing solution during the salt metathesis reaction. A major drawback from the conventional silver-chloride precipitation method is that phosphate ions form a salt precipitate with the silver ion that has a lower solubility constant (Ksp Ag₃PO₄=9×10′) than a salt precipitate formed between the silver ion and the chloride ion (Ksp AgCl=2×10⁻¹⁰). This previously led to a loss of phosphate-containing metabolites as they preferentially precipitated with the silver cations.

The present salt-precipitation methods provided in this disclosure remove a non-metabolite salt while limiting the loss of metabolites, including the loss of phosphate-containing metabolites. The present salt-precipitation methods may remove all or at least some silver salt formed during the salt metathesis reaction while having only a minor impact on metabolites that are in the metabolite solution.

To overcome the loss of phosphate-containing metabolites, a salt-precipitation method of this disclosure is conducted with a fluorous salt of silver during the salt metathesis step of the ionic liquid workflow in the presence of an ionic liquid which comprises a phosphate-containing anion and/or in the presence of a non-metabolite phosphate-containing compound additive. This reaction preferentially precipitates non-metabolite silver phosphate salt(s) without appreciably precipitating phosphate-containing metabolites. The present salt-precipitation methods may further comprise a step of removing an insoluble silver-phosphate precipitate from the aqueous solution comprising metabolites. This may be accomplished by any conventional method for separating a solid from a liquid, including but not limited to, centrifugation, filtration, and/or decanting.

In the present salt-precipitation methods, the non-metabolite phosphate-containing compound additive may be an ionic liquid comprising a phosphate-containing anion and/or any other compound to which one or more phosphate groups are attached. The compound may comprise at least one of the following ions: dihydrogen phosphate (H₂PO₄), hydrogen phosphate (HPO₄²), phosphate (PO₄³), and/or any combination thereof. Suitable non-metabolite phosphate-containing compound additives include any small molecules containing one or several phosphate groups, including monophosphate compounds, diphosphate compounds, triphosphate compounds and/or any mixtures thereof. The monophosphate compounds, diphosphate compounds, triphosphate compounds may be ionic liquids.

The present salt-precipitation methods may be conducted with an ionic liquid which comprises a phosphate-containing anion. Suitable phosphate-containing anions are compounds to which one or more phosphate groups are attached, including dihydrogen phosphate (H₂PO₄), hydrogen phosphate (HPO₄²), phosphate (PO₄³), and/or any combination thereof. Suitable phosphate-containing anions also include compounds containing a monophosphate group, diphosphate group, triphosphate group and/or any mixtures thereof. In some embodiments, a phosphate-containing anion is a phosphate group, including dihydrogen phosphate (H₂PO₄), hydrogen phosphate (HPO₄²), phosphate (PO₄³), or any combination thereof. In some embodiments, a phosphate-containing anion is a monophosphate group, diphosphate group, triphosphate group or any combination thereof.

In the present salt-precipitation methods, an ionic liquid comprising a phosphate-containing anion may be used either alone or in combination with any other ionic liquids which may comprise anions other than a phosphate-containing anion.

Further aspects provide a salt-precipitation method in which a non-metabolite phosphate-containing compound is added as an additive into an ionic liquid solution which may or may not comprise a phosphate-containing anion that is initially added to lyse and quench cells. The non-metabolite phosphate-containing compound may be any compound containing one or more phosphate groups. The non-metabolite phosphate-containing compound may comprise at least one of the following anions: dihydrogen phosphate (H₂PO₄), hydrogen phosphate (HPO₄²), phosphate (PO₄³), and/or any combination thereof. This salt precipitation method with a phosphate-containing additive may be practiced with any ionic liquid with or without a phosphate-containing anion. The phosphate-containing additive is added in excess of phosphate-containing metabolite(s) in order to outcompete the phosphate-containing metabolites.

The phosphate-containing additive may contain dihydrogen phosphate (H₂PO₄⁻) and/or other phosphate-containing molecules. In some applications, the phosphate-containing additive comprises a monophosphate group, diphosphate group, and/or triphosphate group. The H₂PO₄⁻ and/or other phosphate-containing molecules may be added singly or as a mixture of different phosphate-containing molecules.

In further aspects, this disclosure provides a salt-precipitation method in which phosphate-containing compound(s) are added as a combination of a counterion for ionic liquid as well as an additive in the ionic liquid solution that is initially added to lyse and quench the cells. Other ionic liquids may be used in conjunction with an ionic liquid comprising a phosphate counterion to adjust the levels of free phosphate ions following the salt metathesis step.

In the present salt-precipitation methods, non-metabolite silver phosphate salt(s) precipitate out of the metabolite aqueous solution and leave the metabolites in the solution, thus ridding the metabolite solution of the silver salt. Phosphate-containing metabolites largely remain in solution in the present silver-phosphate precipitation methods. The non-metabolite phosphate-containing ions and/or phosphate-containing compounds are in excess compared with the phosphate-containing metabolites, so they outcompete the phosphate-containing metabolites to form insoluble salts with the silver counterion, thus removing the silver counterion from solution.

The non-metabolite phosphate-containing compound can be a counterion in the ionic liquid that is initially added to lyse and quench the cells. In one iteration and as shown in FIG. 1, the phosphate-containing HMIM (1-hexyl-3-methylimidazolium) contains the H₂PO₄⁻ counterion.

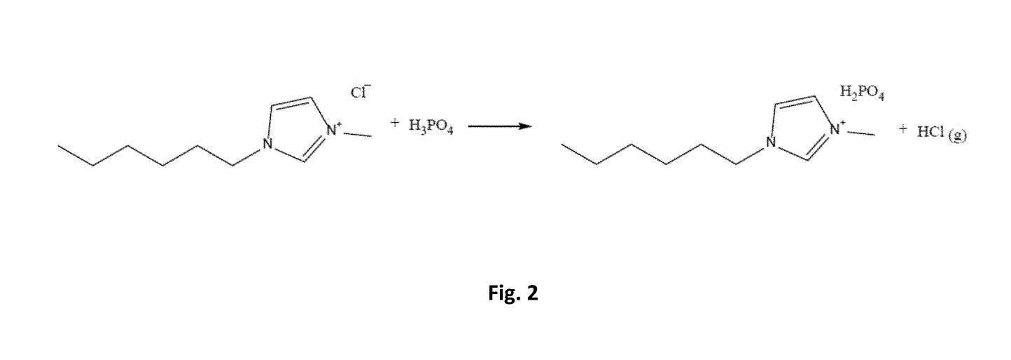

A phosphate-containing ionic liquid may be synthesized by methods described in literature. FIG. 2 is a schematic of a synthesis of a phosphate-containing ionic liquid, the HMIM-H₂PO₄ ionic liquid from HMIM-Cl using methods described in the literature (Maksimov, A L et al. Petroleum Chem, 2014, 54, 4, 283-287). Similar methods may be used to obtain any other ionic liquids containing a phosphate counterion which may contain a monophosphate group, diphosphate group and/or triphosphate group, or others.

Ionic liquids comprising any of cations according to formulas (I)-(VI) may be used in the present salt-precipitation methods when an ionic liquid, comprising a cation of formula (I), (II), (III), (IV), (V) or (VI), is formulated as comprising a phosphate-containing anion and/or with a phosphate-containing additive compound. The ionic liquid comprising a phosphate-containing anion may be used either alone or in combination with other ionic liquids to lyse cells and/or denature proteins in a biologic sample. These other ionic liquids may be selected from any of ionic liquids containing a cation of formula (I), (II), (III), (IV), (V) or (VI) and also containing an anion other than a phosphate-containing anion. These other anions may include acetate, phosphate, formate, carbonate, bicarbonate, nitrate, and/or borate.

A step of cell lysis and/or protein denaturation/enzymatic disruption may be carried out with any ionic liquid. An ionic liquid comprising a phosphate-containing anion and/or a non-metabolite phosphate-containing compound additive are added to the biologic sample at any time prior to the onset of a metathesis reaction with a fluorous salt of silver.

In some applications of the present salt-precipitation method, a phosphate-containing ionic liquid either alone or in combination with other ionic liquids is used to lyse and quench a biologic sample which may comprise cells, body fluids, and/or a tissue.

In some embodiments of a salt-precipitation method, an ionic liquid is formulated with a mixture of anion counterions, provided that one of the counterions in the mixture is a phosphate-comprising counterion.

The ratios of different anions in the ionic liquid can be formulated based on the balanced reaction between a phosphate-containing anion and silver cation. The ratios of the different ion liquid anions can be adjusted to maintain water miscibility of the ionic liquid and to maintain the cell lysing and cell quenching properties of the solution added to cells. The ratios of the different ionic liquid anion species can be adjusted to provide a final metabolite-containing solution with known levels of different ionic liquid anions. These adjustments to the ionic liquid anion species can improve detection of metabolites in a metabolite-containing solution and prevent introduction of excess non-volatile ions into a mass spectrometry analysis while still preventing unwanted precipitation of phosphate-containing metabolites.

In further iterations of a salt-precipitation method of the present disclosure, a non-metabolite phosphate-containing compound is added as a separate phosphate-containing additive to any ionic liquid solution that is initially added to a biologic sample in order to denature proteins/disrupt enzymes and/or lyse cells. The phosphate-containing additive may be added before, during or after the protein denaturing/enzyme disruption/cell lysis and/or during the subsequent stages of the ionic liquid workflow, including prior to an onset of a salt metathesis reaction. The phosphate-containing compound can be dihydrogen phosphate (H₂PO₄⁻) and/or other phosphate-containing molecules. In some iterations, the phosphate-containing compounds are monophosphates, diphosphates, and/or triphosphates. The H₂PO₄⁻ or other phosphate-containing compounds can be added singly or as mixtures of different phosphate-containing molecules. The phosphate-containing compound(s) can be added as a combination of an anion for ionic liquid and an additive comprising a phosphate-containing compound.

In the present salt-precipitation methods, the silver cations are precipitated from the aqueous solution comprising metabolites with phosphate ions which are supplied from: an ionic liquid which comprises a phosphate-containing anion and/or an additive which comprises a phosphate-containing compound. A small, but insignificant for metabolomics analysis, amount of silver counterions may also precipitate with phosphate-containing metabolites. This precipitation is far exceeded by precipitation with phosphate ions which are supplied from: an ionic liquid which comprises a phosphate-containing anion and/or an additive which comprises a phosphate-containing compound.

Further aspects of this disclosure provide a method for obtaining a metabolite sample with a lower salt content, which improves a metabolite peak shape, metabolite resolution, and sensitivity to metabolite ions when analyzed by metabolite detection methods, including LCMS. Methods of the present disclosure may include analyzing metabolites by liquid chromatography-mass spectrometry systems. The analysis may include liquid chromatography (LC), including a high-performance liquid chromatography (HPLC), a micro- or nano-liquid chromatography or an ultra-high pressure liquid chromatography (UHPLC). The analysis may also include liquid chromatography/mass spectrometry (LCMS), ion mobility—mass spectrometry, gas chromatograph/mass spectrometry (GCMS), capillary electrophoresis (CE), or capillary electrophoresis chromatography (CEC).

Further aspects of this disclosure provide methods for removing water-soluble fluorous compounds from an aqueous metabolite solution generated as part of the metabolomics ionic liquid sample preparation method. The water-soluble fluorous compounds are formed during the salt metathesis step of the ionic liquid workflow through a hydrolysis reaction that hydrolyzes a fluorous compound into fluorous compounds that are soluble in water. These hydrolyzed compounds may include a fluorous sulfonate and/or a fluorous sulfonamide. The hydrolysis may be acid-catalyzed or base-catalyzed. A fluorous sulfonate and a fluorous sulfonamide are partially deprotonated upon contact with water, which makes these compounds water-soluble and the compounds migrate from the organic layer into the aqueous solution comprising metabolites.

In the aqueous solution, fluorous sulfonate(s) and/or a fluorous sulfonamide(s) may interfere with detection of metabolites in the sample by liquid chromatography-mass spectrometry, liquid chromatography, including a high-performance liquid chromatography (HPLC), a micro- or nano-liquid chromatography or an ultra-high pressure liquid chromatography (UHPLC), gas chromatograph/mass spectrometry (GCMS), capillary electrophoresis (CE), or capillary electrophoresis chromatography (CEC) or by other metabolite analysis instruments.

This disclosure provides methods which remove fluorous sulfonates, fluorous sulfonamides and/or other fluorous water-soluble by-products from an aqueous solution comprising metabolites. These methods improve the ability and sensitivity for detecting the metabolites in the sample prepared in the ionic liquid workflow.

The fluorous sulfonates and fluorous sulfonamides include those that may be obtained by a hydrolysis of a fluorous compound of formula (VII).

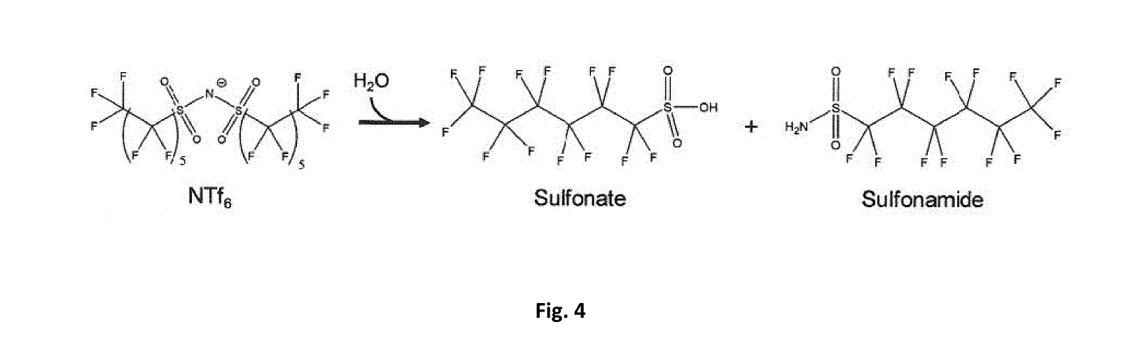

FIG. 4 is a schematic of a hydrolysis reaction of bis((perfluorohexyl)sulfonyl)imide (NTf₆) which results in formation of perfluorohexyl sulfonate and perfluorohexyl sulfonamide.

According to the present methods, the ionic liquid workflow procedure may comprise a step of removing fluorous sulfonate(s) and/or fluorous sulfonamide(s) from an aqueous solution comprising metabolites after the salt metathesis reaction.

In these methods, after completion of the salt metathesis reaction, the aqueous metabolite solution comprising hydrolyzed fluorous sulfonate(s) and/or fluorous sulfonamide(s) is then 1) reacted with a protonation reagent and extracted with a fluorous solvent; and/or 2) passed through a fluorous affinity resin. This produces a metabolite solution which is substantially free from hydrolyzed fluorous sulfonate(s) and/or fluorous sulfonamide(s). By substantially free from hydrolyzed fluorous sulfonate(s) and/or fluorous sulfonamide(s) is meant a solution that includes 10% or less by weight of the hydrolyzed fluorous sulfonate(s) and/or fluorous sulfonamide(s), such as 0.1% or less by weight, 0.03% or less by weight, 0.01% or less by weight, 0.003% or less by weight, 0.001% or less by weight, 0.0003% or less by weight, or 0.0001% or less by weight.

Various fluorous solvents may be used in the present methods for removal of fluorinated sulfonate(s) and/or fluorinated sulfonamide(s) from an aqueous solution comprising metabolites. These fluorous solvents include, but are not limited to, perfluorocarbons (PFCs) and hydrofluoroethers (HFEs). Perfluorocarbons include, but are not limited to, perfluorohexane, perfluoromethylcyclohexane and perfluorodecalin. Hydrofluoroethers include, but are not limited to, nanofluorobutyl methyl ether (e.g., HFE-7100). In some embodiments, the fluorous solvent is a hydrofluoroether, e.g. HFE-7100.

In the present methods for removal of fluorous sulfonate(s) and/or fluorous sulfonamide(s) from an aqueous metabolite solution, various protonation reagents, including organic and/or inorganic acids, may be used in order to lower a pH of the aqueous metabolite solution and partially or substantially protonate at least one of fluorous sulfonate(s) and/or fluorous sulfonamide(s).

A protonation agent may be an inorganic acid, including, but not limited to, a hydrohalic acid, i.e. hydrochloric acid and/or hydrobromic acid, boric acid, phosphoric acid and any mixture thereof. Preferably, an organic acid is used for protonation as a protonation reagent. Suitable organic acids include carboxylic acids. Any of the following organic acids may be added as a protonation reagent to an aqueous solution comprising metabolites and fluorous sulfonate(s) and/or fluorous sulfonamide(s): formic acid, propionic acid, pivalic acid, acetic acid, phenyl acetic acid, chloro-acetic acid, iodo-acetic acid, bromo-acetic acid, butanoic acid, trifluoroacetic acid, and any mixture thereof.

Formic acid is particularly preferred, but the protonation can be also carried out with any other reagent that lowers a pH of the aqueous metabolite solution and protonates at least one from a fluorous sulfonate and/or a fluorous sulfonamide. Typically, the pH is lowered below the pKa value of a particular hydrolyzed fluorous compound to be protonated.

Typically, the pH is lowered below the pKa value of a particular fluorous sulfonate and/or a fluorous sulfonamide to be protonated.

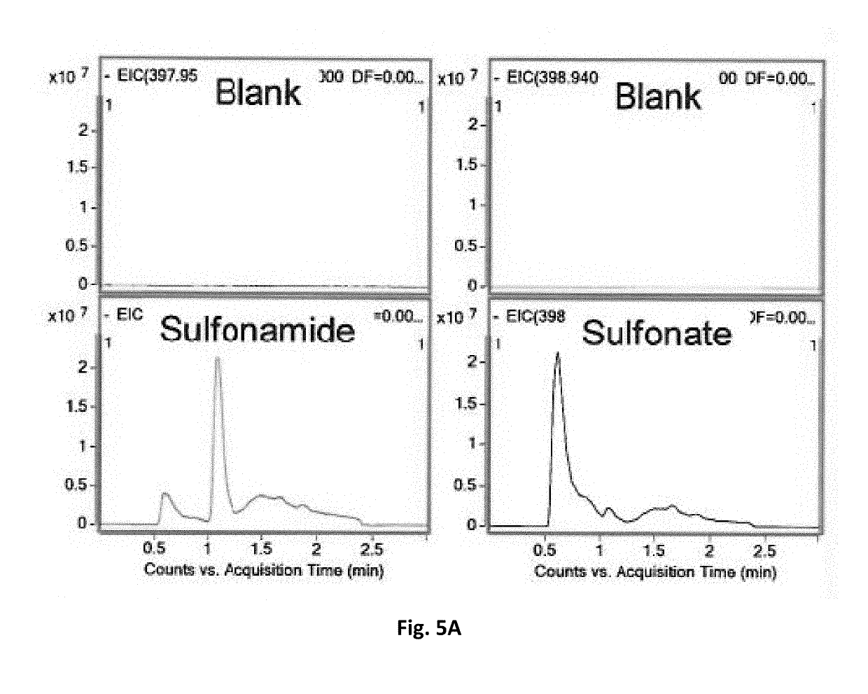

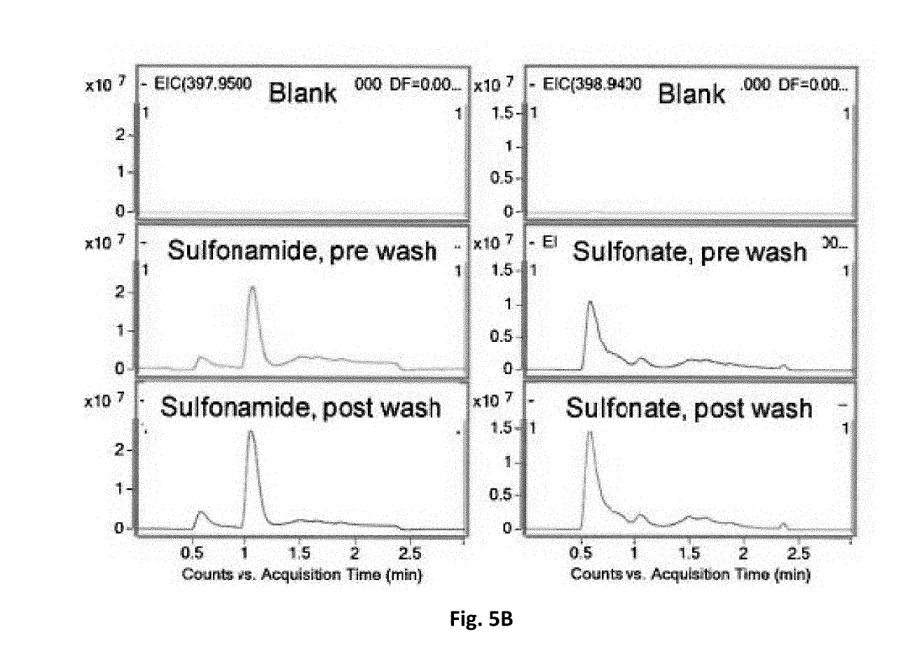

Referring to FIGS. 5A and 5B, they report results of extracting an aqueous metabolite solution comprising metabolites, fluorous sulfonate(s) and fluorous sulfonamide(s) with a fluorous solvent without protonation. Two different fluorous solvents were used for extraction: HFE-7100 was used in extraction in FIG. 5A; and a fluorous branched ether fluorous liquid was used in extraction in FIG. 5B.

As shown in FIGS. 5A and 5B, without protonation, the extraction with a fluorous solvent did not efficiently extract a fluorous sulfonate or fluorous sulfonamide. In the spectra of FIG. 5A, the fluorous sulfonamide and fluorous sulfonate are present in high levels in an aqueous solution comprising metabolites after ten extractions with HFE-7100. In the spectra of FIG. 5B, the fluorous sulfonamide and fluorous sultanate are not reduced in the aqueous solution comprising metabolites after two extractions with a fluorous branched ether fluorous liquid.

In contrast to extraction without protonation, adjusting the pH of the solution comprising metabolites and protonating fluorous sulfonate(s) and/or fluorous sulfonamide(s) with at least one protonation reagent and extraction with a fluorous solvent substantially removes fluorous sulfonate(s) and/or fluorous sulfonamide(s) from an aqueous solution comprising metabolites.

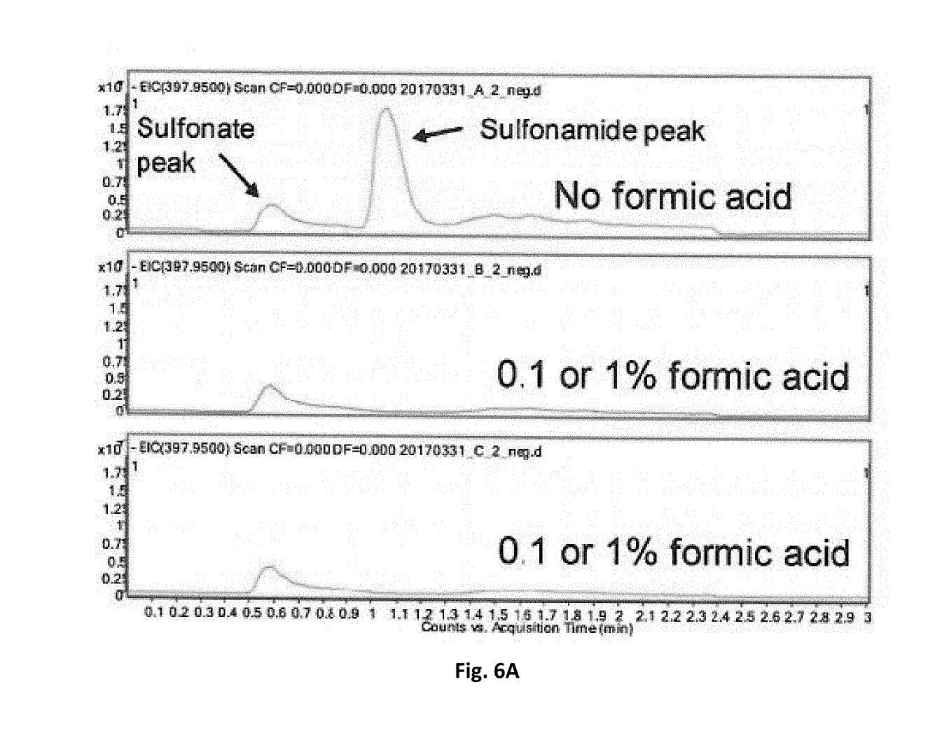

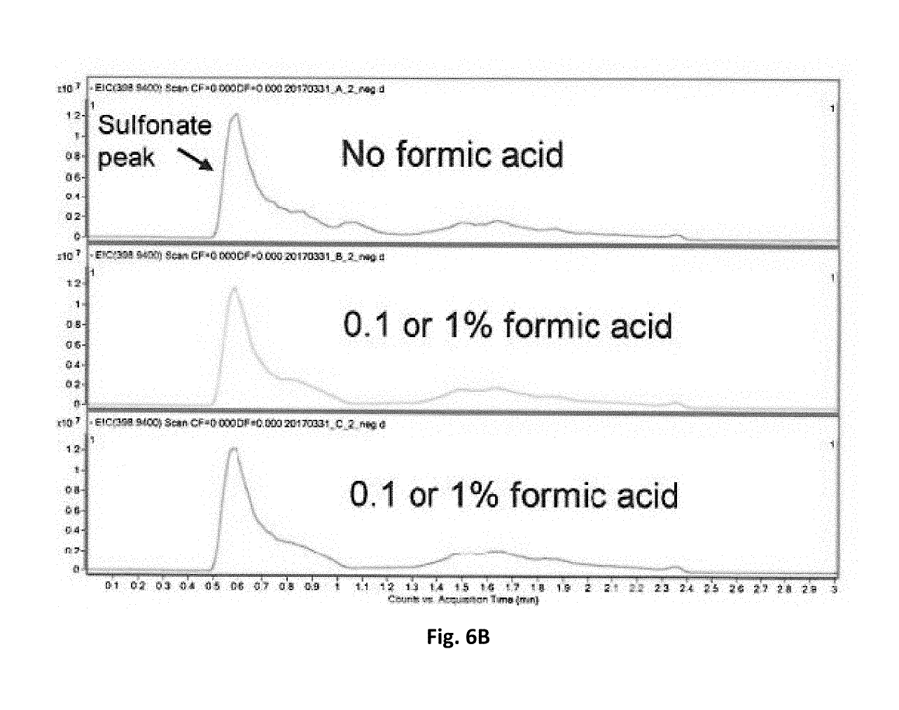

As shown in the spectra of FIG. 6A, protonation with a protonation reagent (formic acid) and extraction with a fluorous liquid (HFE-7100) removes protonated fluorous sulfonamide from an aqueous solution comprising metabolites. As shown in the spectra of FIG. 6B, extraction with a fluorous liquid (HFE-7100) of a fluorous sulfonate which was not protonated, did not remove the fluorous sulfonate from an aqueous solution comprising metabolites. However, lowering the pH further with a stronger protonation reagent and/or by using a protonation agent in a higher concentration, may protonate a fluorous sulfonate, thus facilitating its extraction with a fluorous liquid and its removal from an aqueous solution comprising metabolites.

The steps of this extraction process may be repeated one or more times, such as two or more, 3 or more, 4 or more or 5 or more times, 10 or more as desired to remove any remaining fluorous sulfonate and/or fluorous sulfonamide.

The present methods for removal of fluorous sulfonate(s) and/or fluorous sulfonamide(s) may further comprise interacting an aqueous solution comprising metabolites with a fluorous affinity resin. This may be accomplished by affinity chromatography in which an aqueous solution comprising metabolites is passed through a fluorous affinity resin column. This results in binding of fluorous sulfonate(s) and/or fluorous sulfonamide(s) to the fluorous affinity resin. The majority of metabolites may then be eluted with a polar, water-miscible solvent, while the majority of fluorous sulfonate(s) and/or fluorous sulfonamide(s) remain bound to the column.

Any conventional fluorous affinity resins may be utilized in the methods. Suitable fluorous affinity resins include, but are not limited to, fluorous affinity chromatography resins such as Fluoro-Pak™ and Fluoro-Pak™ II columns (Berry & Associates) and SiliaBond′ Fluorochrom (SiliCycle). Suitable fluorous affinity resins include a fluorous silica which comprises silicon dioxide derivatized with fluorous carbon chains. Suitable fluorous affinity resins also include fluorous styrene-based, benzyl-based and/or divinyl-benzyl-based polymers.

Suitable elution solvents include methanol, ethanol, isopropanol, acetone, acetonitrile, tetrahydrofuran, and any combination thereof. Any of the elution solvents may be used either neat or as a mixture with water in a ratio selected from the range from 99:1 to 1:99 by weight of the solvent to water.

Preferably, the solvent is used as a 0.1% to 80% solution in water.

At least in some embodiments, the elution solvent may comprise an additive. Suitable additives may include a protonation reagent. In some embodiment, the additive is a carboxylic acid. In some embodiments, the additive is a formic acid. In some embodiments, the additive is acetic acid. In some embodiments, the elution solvent comprises acetonitrile and optionally a carboxylic acid which may be formic acid. In some embodiments, the elution solvent is a 0.1% to 80% solution of acetonitrile in water which further optionally comprises from 0.01% to 5% of formic acid.

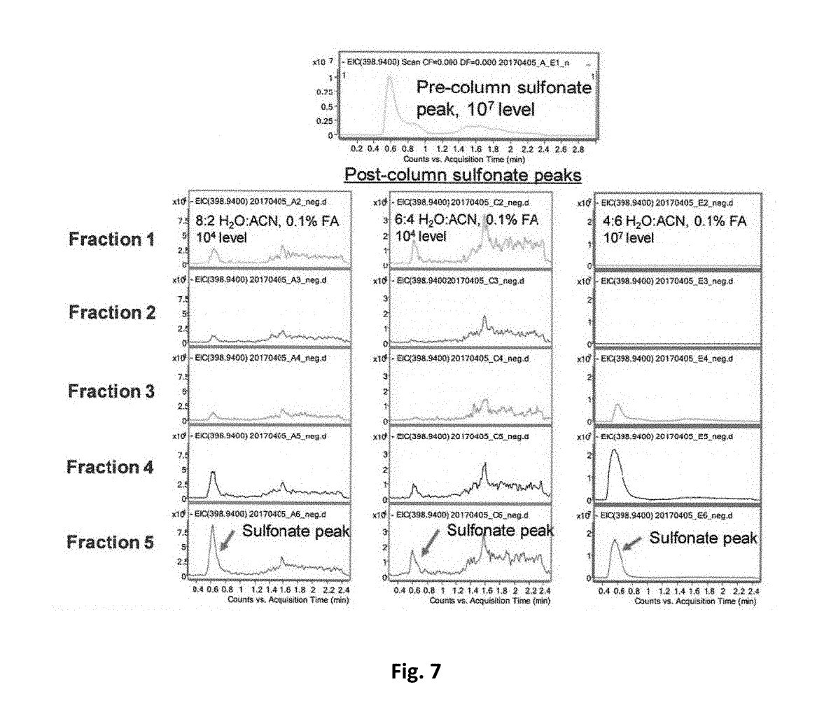

As shown in spectra of FIG. 7, passing a solution comprising metabolites and fluorous sulfonate through a fluorous affinity resin substantially removes the fluorous sulfonate from an eluate comprising metabolites.

Further aspects of this disclosure provide methods and an apparatus for a metabolite analysis of multiple biological micro-samples which comprise cells. In the methods, cells are grown and lysed in a double-bottom container comprising a filter.

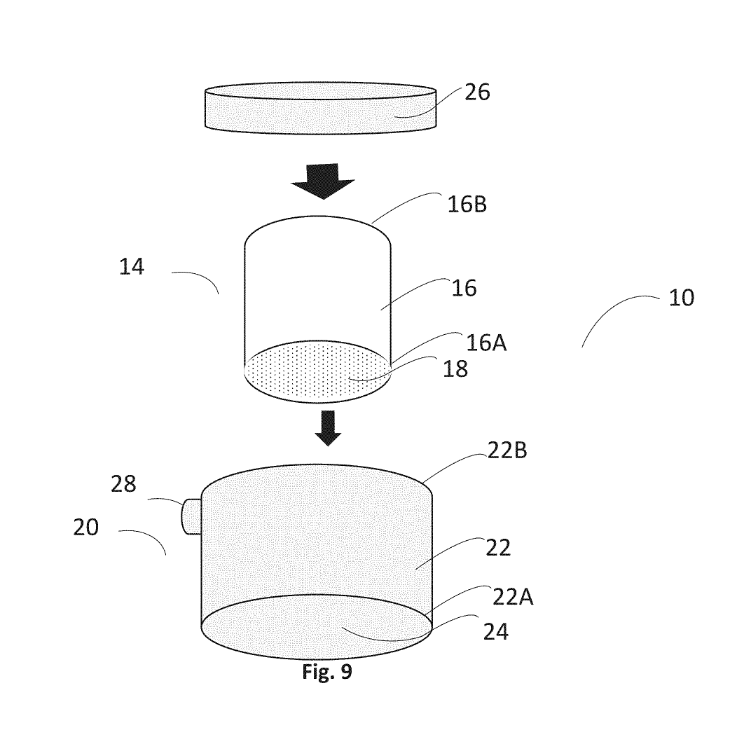

Referring to FIG. 9, it provides a double-bottom container for growing and lysing cells, generally 10. The container 10 comprises an internal chamber, generally 14. The internal chamber 14 is made by a closed wall 16 and a filter 18. The wall 16 may be of any shape typical for a vial for growing cells and containing a liquid. In some embodiments, the wall 16 is cylindrical as found in a vial, bottle, flask, tissue culture plate or a microplate well, and as shown in FIG. 9. Alternatively, the wall 16 of the internal chamber 14 may be rectangular or any other shape. The wall 16 has a bottom edge 16A and a top edge 16B. The bottom edge 16A of the wall 16 is attached to the filter 18 which creates a bottom of the internal chamber 14. The internal chamber 14 is insertable into an external chamber 20.

The external chamber 20 comprises a closed wall 22 with a bottom edge 22A and a top edge 22B. The bottom edge 22A of the external chamber 20 is attached to a pan 24 which creates a bottom of the external chamber 20.

A lid 26 fits over the top edge 22B of the chamber 20 such that a sterile environment is created inside the internal chamber 14 for growing cells. The wall 22 may optionally comprise a vacuum outlet 28 positioned in any location on the wall 22. The vacuum outlet may be used for connecting the container 10 to vacuum pump which can be used for controlling a pressure inside the container 10.

As shown in FIG. 9, the shape and size of the external chamber 20 is designed such that the internal chamber 14 may be placed inside the external chamber 20 such that the filter 18 is suspended over the pan 24, creating a space between the filter 18 and the pan 24 for collecting liquids. A liquid may be filtered through the filter 18 and collected in the external unit 20.

In order to suspend and keep the internal chamber 14 inside the external chamber 20, the length of the wall 16 is shorter than the length of the wall 22. The bottom portion of the wall 16 may be tapered. The internal chamber 14 may be kept suspended inside of the external chamber 20 by any means known to a person of skill. The upper edge 16B of the wall 16 may have a rim that fits over the upper edge 22B of the wall 22 and keeps the internal chamber 14 suspended in the external chamber 20.

A set of internal chambers 14 may be connected by a first frame as is typical in a tissue culture microplate and a set of external chambers 20 may be connected by a second frame as is typical in a tissue culture microplate. The first frame fits into the second frame and keeps each internal chamber 14 of the first frame suspended inside of one of external chambers 20 of the second frame.

In order to grow cells in the container 10, the internal chamber 14 is placed inside the external chamber 20. Cells in growth media are then plated inside the internal chamber 14, and the lid 26 is placed over the container 10. Growth media may be also present in the chamber 20.

The filter 18 is made of a porous material with pores of a size that retain the majority of cells, but allow the growth media and other liquids to filter through the filter 18.

For a metabolomics analysis, the internal chamber 14 is removed from the external chamber 20. The growth media is drained through the filter 18, while the cells are still captured on the filter 18 inside the internal chamber 14. This may be accomplished by applying vacuum or positive pressure to the internal chamber via a manifold, while the internal chamber is removed from the external chamber.

The cells are then optionally washed with a buffer, i.e. phosphate buffered saline which is then also drained through the filter 18. The internal chamber 14 is then inserted back inside the optionally empty external chamber 20 or a separate chamber that can be used as a collection plate. An ionic liquid, optionally with additives, is then added into the internal chamber 14 and cells are lysed. The mixture comprising metabolites and the ionic liquid is filtered through the filter 18 and is collected in the external chamber 20 or other collection plate, while large cell debris and potentially denatured proteins/disrupted enzymes/cell or organelle membrane or membrane pieces remain inside the internal chamber 14.

The internal chamber 14 is then removed from the external chamber 20 or other collection plate. A mixture of metabolites with the ionic liquid in the external chamber 20 or other collection plate is then subjected to the further ionic liquid workflow, including a salt metathesis reaction.

The double-bottom container of this disclosure ensures completion of an ionic workflow analysis on cells without the need to trypsinize and/or transfer cells into a test tube or separate filtering device for processing with the ionic workflow, which prevents changes in metabolites associated with cell distress during the cell harvest and transfer. The methods with the double-bottom container also separate cell debris from a mixture comprising metabolites and the ionic liquid without the need for an additional procedure such as filtration and/or centrifugation. Accordingly, the double-bottom container is suitable for analyzing micro samples, including a sample that comprises only one or very few cells. Multiple samples may be also conveniently analyzed in parallel.

A person of skill will appreciate that while one container 10 is shown in FIG. 9 as a single unit, other embodiments may include a set of internal chambers 14, each insertable into a separate external chamber 20 in a set of external chambers 20. The setting may be similar to a 96-well tissue culture plate in which each well comprises the internal chamber 14 insertable and removable from the external chamber 20, and the wells are connected into a plate by a frame. A multi-container set up ensures a rapid analysis of multiple biologic micro-samples without the need to transfer cell lysates into test tubes or into a separate filter plate in order to remove large cell debris and potentially denatured proteins/disrupted enzymes/cell or organelle membrane or membrane pieces. A person of skill will further appreciate that a multi-container set may be further combined with at least one robotic device such that the cell growth, lysis and analysis is a semi- or fully automated process.

Any cells may be grown and their metabolites analyzed in the container 10, including mammalian tissue culture cells and/or primary cells, bacteria, and/or yeast. Cells may adhere to the filter 18 or they may grow in suspension in the internal chamber 14. Examples of tissue culture cells that adhere include NIH3T3 cells. Examples of tissue culture cells that grow in suspension include Jurkat T-cell lymphocytes. Primary cells may include lymphocytes, hepatocytes, keratinocytes and neurons.

Further aspects of this disclosure provide methods by which metabolites are analyzed. The methods comprise a salt metathesis reaction and/or removal of hydrolyzed fluorous contaminants according to this disclosure. An analysis of a sample comprising metabolites may be then conducted by using any convenient protocol, such as for example by mass spectrometry, infrared spectroscopy, UV-vis spectroscopy, colorimetry and nuclear magnetic resonance spectroscopy. In certain embodiments, chemical analysis is conducted by gas chromatography-mass spectrometry. In other embodiments, a chemical analysis is conducted by liquid chromatography-mass spectrometry and/or ion mobility mass spectrometry.

Methods of the present disclosure may include analyzing metabolites by liquid chromatography-mass spectrometry systems. The analysis may include liquid chromatography, including a high-performance liquid chromatography, a micro- or nano-liquid chromatography or an ultra-high pressure liquid chromatography. The analysis may also include liquid chromatography/mass spectrometry (LCMS), ion mobility—mass spectrometry, gas chromatograph/mass spectrometry (GCMS), capillary electrophoresis (CE), or capillary electrophoresis chromatography (CEC).

Mass spectrometer systems for use in the subject methods may be any convenient mass spectrometry system, which in general contains an ion source for ionizing a sample, a mass analyzer for separating ions, and a detector that detects the ions. In certain cases, the mass spectrometer may be a so-called “tandem” mass spectrometer that is capable of isolating precursor ions, fragmenting the precursor ions, and analyzing the fragmented precursor ions. Such systems are well known in the art (see, e.g., 7,534,996, 7,531,793, 7,507,953, 7,145,133, 7,229,834 and 6,924,478) and may be implemented in a variety of configurations. In certain embodiments, tandem mass spectrometry may be done using individual mass analyzers that are separated in space or, in certain cases, using a single mass spectrometer in which the different selection steps are separated in time. Tandem MS “in space” involves the physical separation of the instrument components (QqQ or QTOF) whereas a tandem MS “in time” involves the use of an ion trap.

An example mass spectrometer system may contain an ion source containing an ionization device, a mass analyzer and a detector. As is conventional in the art, the ion source and the mass analyzer are separated by one or more intermediate vacuum chambers into which ions are transferred from the ion source via, e.g., a transfer capillary or the like. Also as is conventional in the art, the intermediate vacuum chamber may also contain a skimmer to enrich analyte ions (relative to solvent ions and gas) contained in the ion beam exiting the transfer capillary prior to its entry into the ion transfer optics (e.g., an ion guide, or the like) leading to a mass analyzer in high vacuum.

The ion source may rely on any type of ionization method, including but not limited to electrospray ionization (ESI), atmospheric pressure chemical ionization (APCI), electron impact (EI), atmospheric pressure photoionization (APPI), matrix-assisted laser desorption ionization (MALDI) or inductively coupled plasma (ICP) ionization, for example, or any combination thereof (to provide a so-called “multimode” ionization source). In one embodiment, the precursor ions may be made by EI, ESI or MALDI, and a selected precursor ion may be fragmented by collision or using photons to produce product ions that are subsequently analyzed. Likewise, any of a variety of different mass analyzers may be employed, including time of flight (TOF), Fourier transform ion cyclotron resonance (FTICR), ion trap, quadrupole or double focusing magnetic electric sector mass analyzers, or any hybrid thereof. In one embodiment, the mass analyzer may be a sector, transmission quadrupole, or time-of-flight mass analyzer.

### Example 1. Removal of Salt from a Metabolite Mixture

In order to obtain a metabolite mixture, cells are filtered and washed with the PBS/DPBS buffer or isotonic NaCl at a temperature in the range from 0.5° C. to 37° C. Cells are quenched and lysed with ionic liquid HMIM containing phosphate ions as a solution in water (w/v) ±buffer or acid or base. The resulting cell lysate comprising metabolites is passed through a filter. A volume of water and optionally a buffer, acid and/or base is added to clear the hold-up volume of the plate. The lysate is cleaned-up on a C18 SPE column and a mobile phase is used to push polar metabolites off the column.

A test sliver phosphate precipitation reaction was conducted with a metabolite mixture to which HMIM dihydrogen phosphate was added. HMIM was separated from metabolites through a salt metathesis reaction with Ag-NTf₆ in the presence of a fluorous liquid, such as for example, HFE 7100. This reaction results in HMIM being removed into an organic layer comprising HFE 7100, where HMIM forms a salt with NTf₆. In the meantime, silver ions from Ag-NTf₆ are transferred to the phase comprising metabolites. The silver ions form water-insoluble silver phosphate salts. The silver phosphate salt(s) precipitate from the aqueous layer, leaving a metabolite solution that can be analyzed by LCMS with limited ionic species that may lead to metabolite ion suppression and/or peak abundance losses due to salt precipitation of non-volatile salts on parts of the MS. Any hydrolyzed NTf₆ formed is removed using fluorous SPE columns.

The levels of phosphate-containing ions and phosphate-containing compounds can be adjusted to an optimal level for LCMS and/or other metabolite analysis.

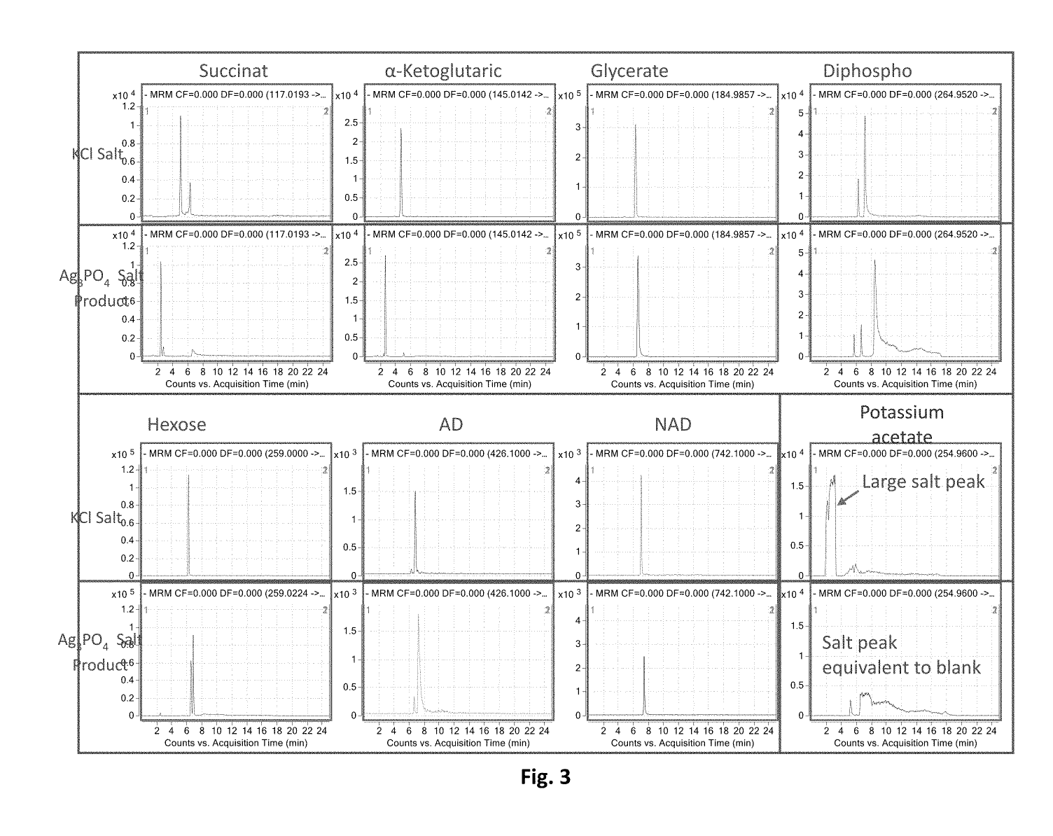

FIG. 3 reports a comparative analysis for some metabolites detected after taking a standard metabolite mixture through the ionic liquid workflow where either a water-soluble KCl salt was formed during the metathesis step as per a conventional procedure (upper panels, referred to as KCl salt product) or a water-insoluble Ag₃PO₄ is formed during the metathesis step as provided in this disclosure (bottom panels, referred to as silver phosphate salt product). For KCl salt formation, HMIM-Cl and K-NTf₆ were reacted in the metathesis reaction. For Ag₃PO₄ salt formation, HMIM-H₂PO₄ and Ag-NTf₆ were reacted in the metathesis reaction.

As shown in spectra of FIG. 3, abundance and peak shapes for metabolites, including phosphate-containing metabolites, are similar across both sample preparation methods. The level of contaminant potassium salts detected is decreased for the sample preparation method that produces the silver (Ag₃PO₄, Ag₂HPO₄, and/or AgH₂PO₄) salt precipitate.

As can be seen in FIG. 3, there is no significant loss of the phosphate-containing metabolites when using the Ag₃PO₄ salt precipitation method as compared to the KCl salt formation method. The HMIM-H₂PO₄ ionic liquid was synthesized from HMIM-Cl using methods described in the literature (Maksimov, A L et al. Petroleum Chem, 2014, 54, 4, 283-287).

### Example 2. Removal of Hydrolyzed Fluorous Compounds

Cells were filtered and washed with PBS/DPBS, isotonic NaCl, or water (temperature can vary from 0.5° C. to 37° C.). Cells were then quenched and lysed with an ionic liquid (HMIM with a counterion in water (50% w/v) ±buffer or acid or base), the cell lysate was passed through a filter, and a volume of water (±buffer or acid or base) was added to clear the hold-up volume of the plate. A metabolite solution cleaned-up on a C18 column and mobile phase (i.e. eluent) is used to push the polar metabolites off the column. The HMIM is removed from the metabolite solution through a salt metathesis reaction with NTf₆ in the presence of a fluorous liquid, like HFE-7100. HMIM goes into the organic layer to form a salt with the NTf₆, and the NTf₆ counterion transfers to the aqueous layer. Any hydrolyzed NTf₆ that is formed is removed by extraction with a fluorous solvent in the presence of a protonation reagent and/or by a chromatography with a fluorous affinity resin.

As shown in FIG. 6A, both 0.1% and 1% formic acid substantially protonate the fluorous sulfonamide, which is removed from the aqueous phase during HFE-7100 extraction.

FIG. 7 reports removal of fluorous sulfonate after passage through a Berry and Associates fluorous resin. Eluate fractions 1-5 were collected after passing each of the following eluents through the fluorous resin: 1) metabolite-containing solution, about 250 μl; 2) 150 μl of the listed eluent (i.e. 8:2 H₂O:ACN with 0.1% FA); 3) 150 μl of the listed eluent (i.e. 8:2 H₂O:ACN with 0.1% FA); 4) 150 μl of H₂O with 0.1% FA; and 5) air. The fluorous resin removes the fluorous sulfonate from the first two eluates for all treatments. The fluorous resin substantially removes the fluorous sulfonate from all eluates (Fractions 1-5) when the H₂O content is 60% or greater.

### Example 3. Analysis of Metabolites

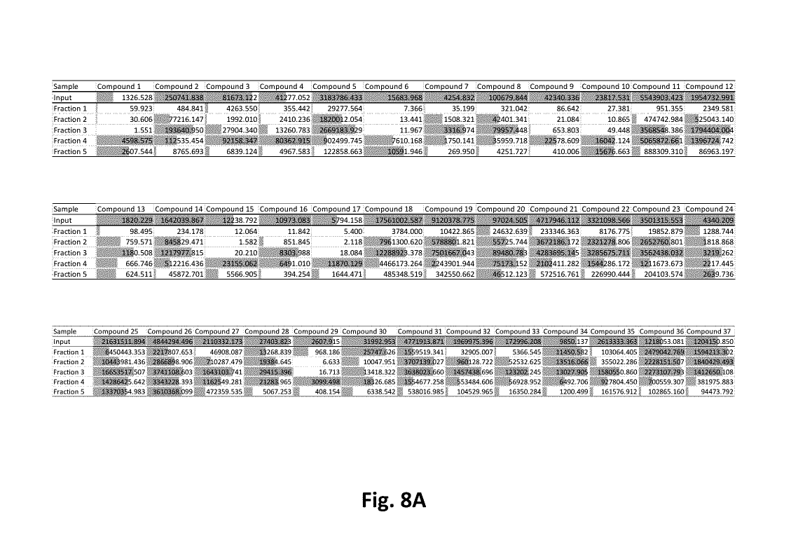

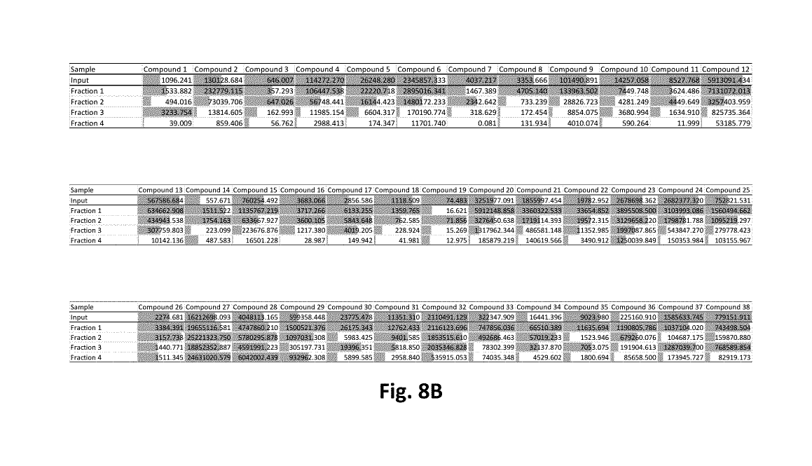

FIG. 8A contains bar graphs showing the relative level of various metabolites before and after passage of the metabolite-containing solution through a Berry and Associates fluorous resin. Eluate fractions 1-5 were collected after passing each of the following eluents through the fluorous resin: 1) metabolite-containing solution, ˜250 μl; 2) 150 μl of 8:2 H₂O:ACN with 0.1% FA; 3) 150 μl 8:2 H₂O:ACN with 0.1% FA; 4) 150 μl of H₂O with 0.1% FA; and 5) air. The highest metabolite levels for most compounds are found in Fractions 2-4, which are substantially free of the fluorous sulfonate (FIG. 7).

FIG. 8B contains bar graphs showing the relative level of various metabolites before and after passage of the metabolite-containing solution through a Silicycle Si-fluorochrom fluorous resin. Eluate fractions 1-4 were collected after passing each of the following eluents through the fluorous resin: 1) metabolite-containing solution, ˜200 μl; 2) 100 μl of 9:1 H₂O:ACN; 3) 50 μl 9:1 H₂O:ACN; and 4) 75 μl of H₂O. The highest levels for most metabolites are found in Fractions 1 and 2, which are substantially free of the fluorous sulfonate.

What is claimed is:

1. A method for preparing a solution comprising metabolites, the method comprising:
reacting a mixture, optionally in the presence of a fluorous solvent, the mixture comprising metabolites and an ionic liquid comprising a phosphate-containing anion and/or a phosphate-containing additive, with a fluorous compound comprising silver cations, and thereby separating the cation of the ionic liquid from the metabolites and obtaining a solution comprising the metabolites and a silver phosphate precipitate.

2. The method of claim 1, wherein the method further comprises a step of removing the silver phosphate precipitate from the solution.

3. The method of claim 1, wherein the phosphate-containing anion is a compound to which one or more phosphate groups are attached.

4. The method of claim 1, wherein the phosphate-containing additive is a compound to which one or more phosphate groups are attached.

5. The method of claim 1, wherein the phosphate-containing anion contains a monophosphate group, diphosphate group, triphosphate group, or any combination thereof.

6. The method of claim 1, wherein the ionic liquid comprises the phosphate-containing additive, and wherein the phosphate-containing additive comprises a monophosphate group, diphosphate group, triphosphate group, or any combination thereof.

7. The method of claim 1, wherein the anion is a mixture of the phosphate-containing counterion with acetate and/or formate.

8. The method of claim 1, wherein the mixture comprises water, acetonitrile, formic acid, fluorous affinity liquid, the ionic liquid with the phosphate-containing anion, and the fluorous anion and the silver cation.

9. The method of claim 1, wherein the mixture comprises a buffer selected from ammonium acetate, ammonium bicarbonate, formic acid, acetic acid, ammonium formate, 4-methylmorpholine, 1-methylpiperidine, triethylammonium acetate, pyrrolidine or any combination thereof.

10. The method of claim 1, wherein the mixture comprises:
a fluorous solvent selected from a perfluorocarbon (PFC), hydrofluoroether (HFE), and any combination thereof; and/or
an organic solvent selected from acetonitrile, HFE-7100, or any combination thereof.

11. The method of claim 1, wherein the fluorous compound has the following formula (VII):
[Z¹—(CH₂)ₘ—SO₂—N(⁻)—SO₂—(CH₂)ₚ—Z²].M⁺ (VII)
wherein: M⁺ is silver;
Z¹ and Z² are independently a perfluoroalkyl, an alkyl, a substituted alkyl, a perfluoroaryl, an aryl, or a substituted aryl, wherein Z¹ and Z² include together a combined total of 8 or more fluorinated carbon atoms;
and m and p are independently 0, 1 or 2.

12. The method of claim 1, wherein the method further comprises removing a hydrolyzed fluorous compound from the metabolite solution, the method comprising:
extracting the metabolite solution comprising the hydrolyzed fluorous compound with a fluorous solvent in the presence of a protonation reagent, and thereby lowering a pH of the solution at or below the pKa value of the hydrolyzed fluorous compound, protonating the fluorous compound and obtaining an aqueous phase comprising metabolites and an organic phase comprising the protonated fluorous compound; and
separating the aqueous phase comprising metabolites from the organic phase.

13. A method for removing a hydrolyzed fluorous compound from a metabolite solution, the method comprising:
a) extracting the metabolite solution comprising the hydrolyzed fluorous compound with a fluorous solvent in the presence of a protonation reagent, and thereby lowering a pH of the solution at or below the pKa value of the hydrolyzed fluorous compound, protonating the fluorous compound and obtaining an aqueous phase comprising metabolites and an organic phase comprising the protonated fluorous compound; and
b) separating the aqueous phase comprising metabolites from the organic phase.

14. The method of claim 13, wherein the method further comprises:
c) loading the metabolite solution comprising the hydrolyzed fluorous compound onto a fluorous affinity resin, and thereby binding the fluorous compound to the resin; and
d) eluting the solution comprising metabolites.

15. The method of claim 13, wherein the water-soluble fluorous compound is a fluorous sulfonate; fluorous sulfonamide, or any combination thereof.

16. The method of claim 13, wherein the fluorous solvent is a perfluorocarbon, hydrofluoroether, or any mixture thereof.

17. The method of claim 13, wherein the protonation reagent is hydrochloric acid, hydrobromic acid, boric acid, phosphoric acid, formic acid, carboxylic acid, acetic acid, or any mixture thereof.

18. The method of claim 13, wherein the fluorous affinity resin comprises silicon dioxide derivatized with fluorous carbon chains, a fluorous styrene-based polymer, a fluorous benzyl-based polymer, a fluorous divinyl-benzene polymer, or any combination thereof.

19. The method of claim 13, wherein the elution solvent comprises methanol, ethanol, isopropanol, acetone, acetonitrile, tetrahydrofuran, or any mixture thereof; and wherein the elution solvent optionally comprises one or more from the following: water, a protonation reagent and a polar organic solvent.

20. The method of claim 1, wherein the method further comprises the following steps for:
a) growing cells in a double-bottom container comprising an internal chamber with a filter bottom, the internal chamber being suspended in an external chamber and the internal chamber being insertable and removable from the external chamber; wherein the cells are optionally adhered to the filter bottom;
b) filtering the cells adhered to the filter bottom to remove growth media;
c) optionally washing the cells with an isotonic solution;
d) lysing the cells by contacting the cells with an ionic liquid in the internal chamber, thereby obtaining a mixture comprising metabolites and the ionic liquid;
e) filtering the mixture through the filter bottom;
f) collecting the mixture in the external chamber; and
g) reacting the mixture according to claim 1.
